(19) United States
(12) Patent Application Publication
(10) Pub. No.: US 2007/0081525 A1
(43) Pub. Date: Apr. 12, 2007

(54) Communication method and system of an internet phone

(75) Inventor: Qian Jian Jun, Taipei (TW)

Correspondence Address: BIRCH STEWART KOLASCH & BIRCH, PO BOX 747, FALLS CHURCH, VA, 22040-0747, US

(73) Assignee: Wistron Corporation

(21) Appl. No.: 11/389,146

(22) Filed: Mar. 27, 2006

(30) Foreign Application Priority Data
Sep. 23, 2005 (TW) 94133218

(51) Int. Cl. H04L 12/66

(52) U.S. Cl. 370/356

(57) ABSTRACT

A communication method and system of an internet phone is disclosed. The dial point via a server sends an invitation to a receive point which is not available. Subsequently, the receive point or server will decide the following step according to the protocol tag from the dial point. By the session initiation protocol (SIP), the present invention can increase the transmission rate of the messages and decrease the use of the network bandwidth.

### BACKGROUND OF THE INVENTION

1. Field of the Invention

The present invention relates to an internet protocol (IP) phone, and more particularly to a communication method and system of the IP phone by a session initiation protocol (SIP).

2. Description of the Prior Art

Due to widely spread of the internet and popular service of the broadband network, the message transmission for the voice and images streams via internet is a hot topic, especially the voice over internet protocol (VoIP), which is a protocol to transfer the voice or the image streams by internet. The method for VoIP is first transforming the data of voice and image streams to compressed data packets, and subsequently transferring these digitized packets via the network of internet protocol (IP). In the past, due to the limitation of the bandwidth, the voice transmission by the method of VoIP can not compete with that transferred by a traditional telephone. However, owing to the progress of communication technology, the bandwidth is gradually increasing, and the effect of transmission by VoIP is greatly improved as well.

The IP phones by the method of VoIP were rapidly developed, and among these, the one based on a session initiation protocol (SIP) is especially outstanding. In traditional IP phones on dealing with Do-Not-Disturb (DND), the receive point sends not only a DND tag but also a pre-recording voice stream to the dial point, and then the voice stream is played by the dial point. The previous header, DND, is one of the defined code in the message structure of SIP, according to that the message of SIP consists of a header and a message body.

FIG. 1 schematically illustrates a flowchart of a traditional communication method by using SIP. When the receive point 100 is on an unavailable condition, the phone can be set on the mode of DND by the user. If an invitation from the dial point 200 and sending a message to the receive point 100 via the server 300 (Step 1-Step 2), the receive point 100 will orderly send a message, containing a DND header, via the SIP server 300 (Step 3-Step 4) and a pre-recording voice stream-to the dial point 200, (Step 5) and then the dial point 200 will play the voice stream after receiving the message.

In the foregoing communication method by SIP, the bandwidth of the network is massively occupied, which leads to a poor efficiency of bandwidth use, when sending a pre-recording voice stream to the dial point 200. Therefore, a new communication method is necessary to develop, that can be consulted with each other by the client and the server to decide how to exert the associating function. Simultaneously it should be complies with SIP and further applied to the other functions, similar to DND, such as voice message, voice mail, call block, call transfer, incoming ring tone, etc. Based on this method, it will be not only decreasing the use of the network bandwidth, but also increasing diversified functions of IP phone.

### SUMMARY OF THE INVENTION

In view of the foregoing, it is an object of the present invention to provide applications of an internet protocol (IP) phone based on Session Initiation Protocol (SIP), so that the IP phone is able to quickly response and reduce the use of the network bandwidth, such as one embodiment about the function of do-not disturb (DND).

According to this object, the present invention provides a communicating method and system of IP phone. According to one embodiment of the present invention, when the dial point sends an invitation via the server to a receive point which is in an unavailable condition, the receive point or the server will send a response with a protocol tag. Subsequently the receive point or the server will decide the following step by the protocol tag. According to the protocol tag, the dial point can play the pre-recording prompting voice stream or image stream within. Moreover, the server can function the voice message and prompt the dial point to proceed to leave a message.

### BRIEF DESCRIPTION OF THE DRAWINGS

FIG. 1 shows a flowchart of a traditional communication method by session initiation protocol (SIP).

FIG. 2 schematically illustrates the block diagram of a communication system according to the present invention.

FIG. 3 is the flowchart, showing the communication method of initiation protocol (IP) phone, according to one embodiment of the present invention.

FIG. 4 and FIG. 5 show the flowcharts of the communication methods of IP phone, according to the second embodiment of the present invention.

FIG. 6 and FIG. 7 show the flowcharts of the communication method of IP phone, according to the third embodiment of the present invention.

### DESCRIPTION OF THE PREFERRED EMBODIMENT

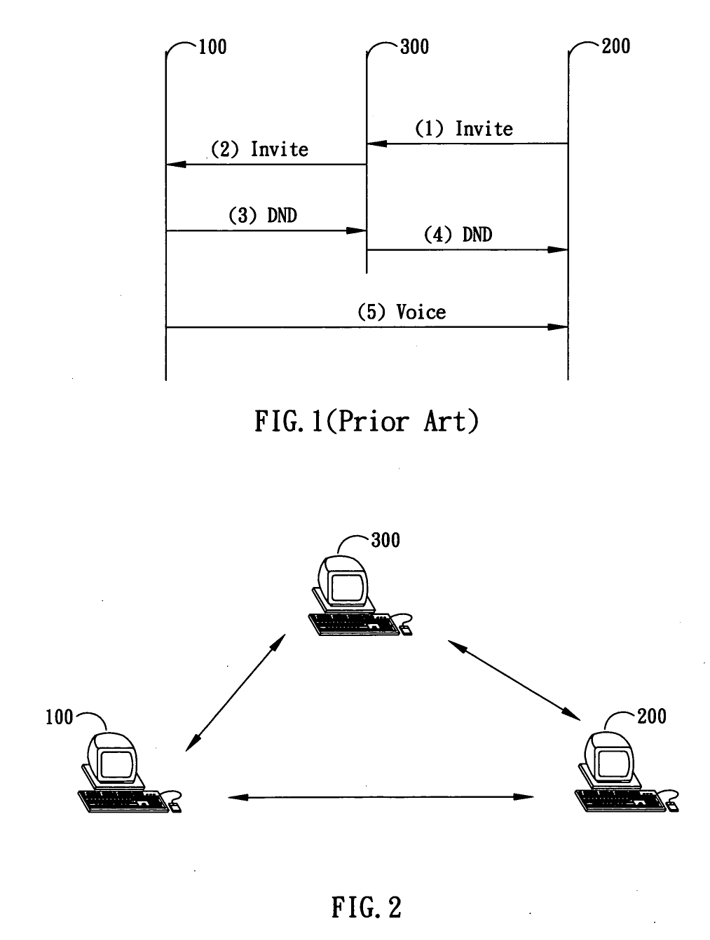

The embodiments of this invention disclose an internet phone based on session initiation protocol (SIP), but they are not intended to limit the scope of the present invention and can be adapted for the other communication protocols, as long as the principle or the structure of the protocols are similar with that of SIP. While drawings are only illustrated two clients and a server, it is appreciated that the present invention can be applied on a more complex network of communication systems, for instant, the amount of the clients may be greater than that in the embodiments, or the amount of the servers may be greater than one. The dial point 100 and the receive point 200 in FIG. 1 may be including desktop computers, laptop computers, personal digital assistants (PDA), or internet protocol (IP) phones, and so on, as long as they communicate based on SIP. In addition, they may be communicated by either wire-line or wireless method, as long as the messages are transferred or decoded between the receive point 100 and the dial point 200 via the SIP server 300.

FIG. 2 schematically illustrates the block diagram of the communication system, according to this invention. This system adopts a structure of the client-server network. The clients are the receive point 100 and the dial point 200, which use the phones based on voice over internet protocol (VoIP). And the network server 300 also bases on VoIP.

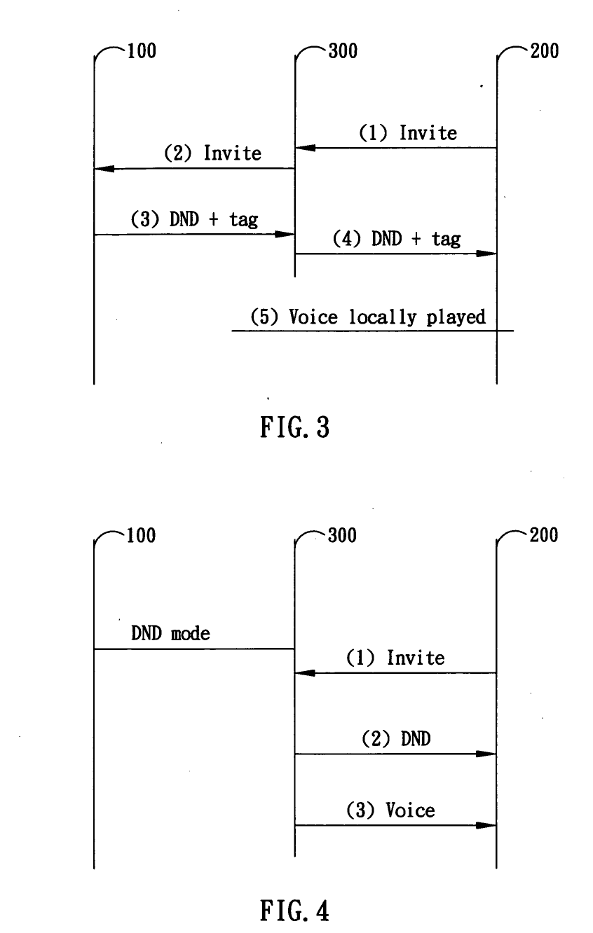

FIG. 3 shows the flowchart of the communication method of IP phone according to an embodiment of the present invention. When the dial point 200 sends an invitation, the message will be received by the receive point 100 via the SIP server 300. (Step 1-2) If the receive point 100 can not reply the invitation, and the receive point 100 sets itself on the mode, Do-Not-Disturb (DND). After received the invitation, the receive point 100 will send the messages with a DND header and a protocol tag to the dial point 200 via the SIP server 300. (Step 3-Step 4) When the dial point 200 receives the message and decodes the tag, the dial point recognizes that the receive point asked for playing the pre-recording voice (Step 5). The dial point 200 can recognize the receive point is on the DND mode and properly try to connect again after a couple of minutes. The previous DND header is a defined code of SIP, and the protocol tag is another code added by the present invention. Otherwise, there are several kinds of the other embodiments for the present invention. For example, the protocol tag in the present invention can be defined as another header of SIP and the value of the header can be arbitrarily chosen, as long as it is not defined by SIP. In addition, the protocol tag is also able to hide inside the message body of SIP. In spite of which method taken to apply to the protocol tag of the present invention, the structure of SIP will not be affected, so that it is compatible with the clients and servers based on SIP. In case of ether clients 100, 200 or the server 300 can not recognize the protocol tag of the present invention, the client 100, 200, and the server 300 will immediately exchange to the traditional communication method, such as the illustration in FIG. 1. The detail communication method will not mention again here.

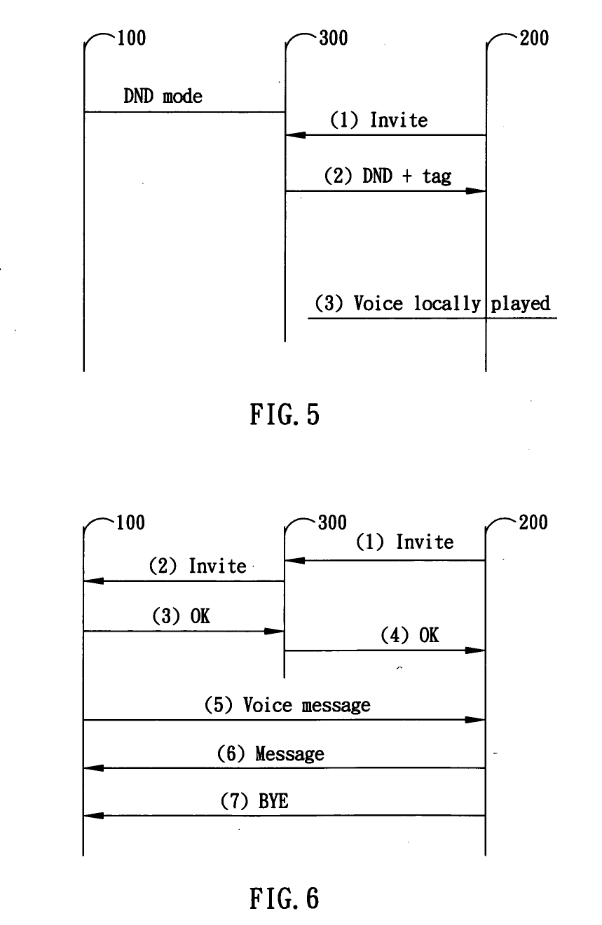

FIG. 4 and FIG. 5 show the flowcharts of a communication method of IP phone, according to the second embodiment of the present invention. FIG. 4 shows a method without using the protocol tag of the present invention, but in contrast, FIG. 5 shows a method applying it. When either the clients 100, 200 or the server 300 can not recognize the protocol tag, the client 100, 200, and the server 300 will immediately exchange to the traditional communication method as shown in FIG. 4. When the receive 100 expects that the invitation will not be replied, the client 100 will inform the server in advance that its mode is on DND. When the dial point 200 will send messages to the receive point 100 via the server 300, the SIP server 300 will directly send the message, which consists of a DND header (Step 2), and a pre-recording voice stream (Step3) to the dial point 200, because the SIP sever 300 has already known that the receive point 100 is on DND mode. After received the message and played the received voice stream, the dial point 200 can recognize the receive point is on DND mode. Compared with that in FIG. 1, the difference is that the server 300 is not necessary to communicate with the receive point 100 any more, and as a result, the use of the bandwidth of the network can be reduced.

The embodiment in FIG. 5 also adopts the protocol tag according to the present invention. However, the use of the bandwidth of the network can be further reduced. When the dial point 200 intends to send an invitation to the receive point 100 via the SIP server 300 (Step 1), the SIP server 300, which has gotten the information that the receive point is on the DND mode in advance, will send a message contained the DND header and the protocol tag to the dial point 200 (Step 2). After received the protocol tag and recognized that the SIP server 300 asked to play the pre-recording voice stream, which stored in the dial point 200, by itself, the dial point 200 can recognize that the receive point is on DND mode. Compared with that in FIG. 4, the difference is that the server 300 in FIG. 5 is not necessary to send the message contained the pre-recording voice stream to the dial point 200, and as a result, the use of the bandwidth of the network can be further reduced.

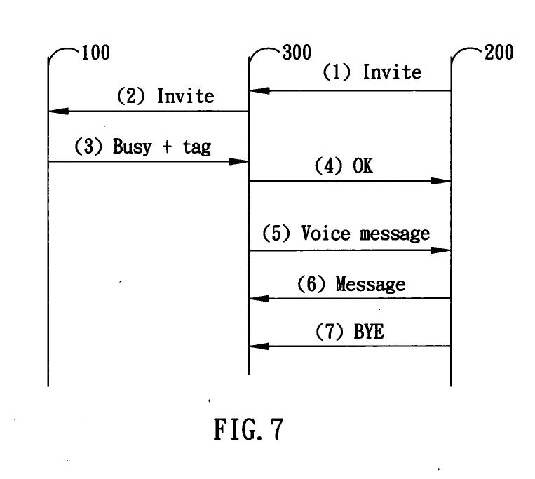

FIG. 6 and FIG. 7 show the flowcharts of a communication method of IP phone, according to the third embodiment of the present invention. FIG. 6 shows a method without using the protocol tag of the present invention, but in contrast, FIG. 7 shows a method applying it. When either the client 100, 200 or the server 300 is not able to recognize the protocol tag, the clients 100, 200, and the server 300 will immediately exchange to the traditional communication method as shown in FIG. 6. In FIG. 6 and FIG. 7, the embodiments show the flowchart of the function of voice message based on the communication method of SIP. The function of voice message is a service similar with an answering machine. When the client is not able to answer the call, it can be automatically to record the message from the dialing user, and the message can be re-played by the client itself. In addition, the user can record his greetings to the dialing client via the voice message. Suppose both the SIP server and the receive point 100 have the function of voice message. While the receive point 100 is on busy (or not available), simultaneously the dial point sends an invitation (Step 1), that is via the SIP server 300 to the receive point 100 (Step 2). So that the receive point 100 replies a response to the dial point 200 via the SIP server 300. (Step 3-Step 4) In this embodiment, the response sent by the receive point is defined as OK, which is a defined header of SIP and the value is 200. It is to be understood that the header in the embodiment is not limited to use OK, other similar headers are also available. Subsequently, the receive point 100 activates its voice message (box) (Step 5) and informs the dial point 200, and then the dial point 200 leaves the message in the voice message of the receive point 100 (Step 6) and hangs up. The previous Step 5 and Step 6 can be adopted the real-time protocol (RTP) and the Step 7 can use a header, BYE.

In FIG. 7, the protocol tag according to the third embodiment of the present invention can further reduce the use of the network bandwidth. While the receive point 100 is on busy (or not available), simultaneously the dial point 200 sends an invitation (Step 1), that is via the SIP server 300 to the receive point 100 (Step 2). The receive point 100 will send a message consisted of a header, BUSY, and a protocol tag, (Step 3) which requests the SIP server 300 to activate its voice message (box), to the SIP server 300. Subsequently, the SIP server 300 sends a header, OK, to reply the dial point 200 (Step 4), functions the voice message on itself, and then informs the dial point 200 (Step 5). Thereafter, the dial point 200 can leave the message in the voice message on SIP server 300 (Step 6), and hangs up (Step 7). Compared with that in FIG. 6, the difference is that the dial point 200 only needs to leave the message in the voice message on SIP server 300, but not necessary to send a message further to the receive point 100. As a result, the use of the bandwidth of the network can be further reduced.

Although specific embodiments have been illustrated and described, it will be appreciated by those skilled in the art that various modifications may be made without departing from the scope of the present invention, which is intended to be limited solely by the appended claims. For instance, one of the previous embodiments disclosed that the protocol tags apply on the pre-recording and playing the voice stream, and voice message according to the present invention. However, that can be also applied on other embodiments of the IP phone communication, essentially including the voice mail, call block, call transfer, incoming ring tone, etc. Otherwise, the functions, such as recording and playing the voice stream, and message leaving, disclosed in the previous embodiments may extend to the data of the images and multi-media.

What is claimed is:

1. A communication method of an internet phone, comprising:
sending an invitation by a- dial point to a receive point via a server when said receive point is not available thereof;
sending a response to said dial point from said receive point or said server, wherein a protocol tag is enclosed within; and
proceeding the following prompting step according said protocol tag of said response by said dial point or said server.

2. The communication method of internet phone according to claim 1, wherein said dial point, said receive point, said server, said invitation, said response, and said tag all comply with a session initiation protocol (SIP)

3. The communication method of internet phone according to claim 1, wherein said dial point and said receive point are phones, which comply with a voice over internet protocol (VoIP).

4. The communication method of internet phone according to claim 2, wherein said tag is defined as a header of said SIP.

5. The communication method of internet phone according to claim 2, wherein said tag is defined inside a message of said SIP.

6. The communication method of internet phone according to claim 1, wherein said response is sent from said receive point, via said server, and to said dial point.

7. The communication method of internet phone according to claim 6, wherein said prompting step comprising:
playing a prompting voice stream or an image stream, which are pre-recorded in said dial point, by said dial point after decode said protocol tag by said dial point.

8. The communication method of internet phone according to claim 1, further comprising:
directly sending said prompting voice stream or said image stream to said dial point for playing by said receive point, when said dial point, said receive point or said server can not decode said protocol tag.

9. The communication method of internet phone according to claim 1, before sending said invitation by said dial point, further comprising:
informing said server in advance by said receive point that said receive point is not able to reply the invitation.

10. The communication method of internet phone according to claim 9, wherein said response is sent from said server to said dial point.

11. The communication method of internet phone according to claim 10, wherein said step comprising:
playing said voice stream or said image stream, which are pre-recorded, after decode said protocol tag by said dial point.

12. The communication method of internet phone according to claim 11, further comprising:
directly sending said voice stream or said image stream to said dial point for playing by said server, when said dial point, said receive point or said server can not decode said protocol tag.

13. The communication method of internet phone according to claim 1, wherein said response is sent by said receive point.

14. The communication method of internet phone according to claim 13, further comprising:
activating a voice message on said server by said server itself and informing said dial point to proceed to leave a message, after said server decodes said protocol tag.

15. The communication method of internet phone according to claim 14, further comprising:
activating said voice message on said receive point by said receive point and directly prompting said dial point to proceed to leave a message, when said dial point, said receive point or said server is not able to decode said protocol tag.

16. A communication system of an internet phone, comprising:
a dial point sends an invitation; and
a server, which is receiving said invitation, wherein a receive point or said server sends a response to said dial point, said response containing a protocol tag and said dial point deciding following step according to said protocol tag of said response.

17. The communication system of an internet phone according to claim 16, wherein said dial point, said receive point, said server, said invitation, said response, and said protocol tag all comply with a session initiation protocol (SIP).

18. The communication system of an internet phone according to claim l6, further comprising:
an apparatus, which pre-records voice stream or image stream within, and plays said streams after said dial point decodes said protocol tag.

19. The communication system of an internet phone according to claim 16, wherein said server further comprising:
an apparatus, which receives the unavailable condition of the said receive point in advance.

20. The communication system of an internet phone according to claim 16, further comprising:
a voice message, which is activated after said protocol tag was decoded, and to prompt said dial point proceeding to leave message.
